(19) United States
(12) Patent Application Publication
(10) Pub. No.: US 2013/0007591 A1
(43) Pub. Date: Jan. 3, 2013

(54) SYSTEM AND METHOD FOR CREATING AN E-COMMERCE WEBSITE IN REAL-TIME

(75) Inventors: Chetan Jagatkishore Kothari, Bangalore (IN); Pawan Chhabra, Faridabad (IN)

(73) Assignee: INFOSYS LIMITED, Bangalore (IN)

(21) Appl. No.: 13/237,148

(22) Filed: Sep. 20, 2011

(30) Foreign Application Priority Data
Jun. 30, 2011 (IN) 2213/CHE/2011

(51) Int. Cl. G06F 17/00

(52) U.S. Cl. 715/234

(57) ABSTRACT

A system and computer-implemented method for creating one or more e-commerce websites in real-time is provided. The methodology for creating one or more e-commerce websites in real-time comprises receiving, via a user interface on a computing device, request to access a tenant's website. The methodology further comprises identifying, using a computer system, a tenant corresponding to the received request. Further, the methodology comprises associating, using the computer system, one or more e-commerce applications, corresponding to the identified tenant, to the tenant's website. The methodology also comprises applying, using the computer system, one or more predetermined changes to the tenant's website corresponding to one or more predefined policies for generating the e-commerce website.

### FIELD OF THE INVENTION

The present invention relates to the field of e-commerce. More particularly, the present invention provides a system and method that facilitates creation of an e-commerce website in real-time based on an organization's requirements.

### BACKGROUND OF THE INVENTION

With advancement in information technology, internet has become the new face of electronic commerce. Identifying the extensive reach of internet and World Wide Web, many businesses today build and manage websites to either promote their products/business or to sell their products online. In order to automate the online business, the website of the corresponding business further includes various e-commerce applications. E-commerce applications are services through which commercial activity is conducted through the internet.

Presently, each website is created based on the requirements of an organization/business. Further each website includes various e-commerce applications, such as a search component, a text component, a payment form, and so forth. For example, an organization, such as Ebay, in order to build its website, provides its requirements to a developer. Subsequently, the developer designs the layout of the website and further links the customized e-commerce applications/components, corresponding to the requirements of the organization, to the related website. The website is thereafter stored in a server and is assigned a unique Uniform Resource Locator (URL). In case another business wants to build a similar website, the developer has to develop the website from scratch. It may be apparent to a person skilled in the art that to develop a website from scratch a developer has to invest his time, skill, and effort, which at times is quite expensive. Moreover, the server would require designated storage area for each of the similar websites developed. This in turn would result in constraining the available data space at the server.

In light of the abovementioned disadvantages, there is a need for a method and a system to develop an e-commerce website in real-time, based on the requirements of the organization. Further, the development of the e-commerce website should require minimal effort from a developer/system administrator and should also utilize the storage capacity of the server economically.

### SUMMARY OF THE INVENTION

A computer-implemented method for creating one or more e-commerce websites in real-time is provided. In various embodiment of the present invention, the computer-implemented method for creating one or more e-commerce websites in real-time comprises receiving, via a user interface on a computing device, request to access a tenant's website. The method further comprises identifying, using a computer system, a tenant corresponding to the received request. Further, the method comprises associating, using the computer system, one or more e-commerce applications, corresponding to the identified tenant, to the tenant's website. The method comprises applying, using the computer system, one or more predetermined changes to the tenant's website corresponding to one or more predefined policies for generating the e-commerce website.

In an embodiment of the present invention, the computer-implemented method for identifying the tenant corresponding to the received request further comprises categorizing the tenant based on a tenant ID, wherein the tenant ID is an alphanumeric code unique for each tenant.

In an embodiment of the present invention, the tenant ID corresponding to the tenant is further associated with one or more predefined policies, wherein the one or more predefined policies includes at least one tenant requirement.

In an embodiment of the present invention, the computer-implemented method for associating one or more e-commerce applications corresponding to the identified tenant further comprises identifying, using the computer system, the one or more e-commerce applications based on the tenant ID corresponding to the tenant. The method further comprises retrieving, using the computer system, the identified one or more e-commerce applications from an e-commerce repository.

In an embodiment of the present invention, the e-commerce repository is ATG Commerce Server.

In an embodiment of the present invention, the one or more predetermined changes comprise at least one of color of the website, font used in the website, placement of one or more data in the website.

In an embodiment of the present invention, the computer-implemented method for creating one or more e-commerce websites in real-time, further comprises defining, using the computer system, one or more variations on the user-interface layers of the one or more e-commerce applications associated with the tenant's website. Further, the method comprises implementing, using the computer system, one or more business rules at the tenant's website corresponding to the one or more predefined policies.

In an embodiment of the present invention, the one or more variations on the user-interface layers of the one or more e-commerce applications comprises at least one of structural variations, aesthetical variations, and functional variations.

In an embodiment of the present invention, the one or more variations on the user-interface layers of the one or more e-commerce applications, corresponding to the identified tenant, are defined based on the one or more predefined policies corresponding to the tenant.

A system for creating one or more e-commerce websites in real-time is provided. In an embodiment of the present invention, the system for creating an e-commerce website in real-time comprises an e-commerce repository and a product extension framework. The e-commerce repository, in communication with a computer system, is configured to store one or more pre-developed e-commerce applications. The product extension framework, in communication with the computer system, is configured to generate a tenant's website including at least one e-commerce application in real-time, wherein the at least one e-commerce application is selected from the one or more pre-developed e-commerce applications.

In an embodiment of the present invention, the at least one e-commerce application is selected based on one or more predefined policies corresponding to the tenant.

In an embodiment of the present invention, the product extension framework comprises a tenant repository, a page variation module, a look and feel module, a page composition module, and a request processing module. The tenant repository, in communication with the computer system, is configured to store tenant IDs' of one or more tenants, wherein the tenant ID is a unique alphanumeric identification code corresponding to a tenant. The page variation module, in communication with the computer system, is configured to assign a preset layout at a tenant's website based on one or more predefined policies, wherein the one or more predefined policies are associated with the tenant ID of the corresponding tenant. The look and feel module, in communication with the computer system, is configured to define the color and style attributes of the tenant's website. The page composition module, in communication with the computer system, is configured to define the composition/content of the tenant's website. The request processing module, in communication with the computer system, is configured to process plurality of computational processes, invoked by one or more computing devices, corresponding to an e-commerce application at the tenant's website.

In an embodiment of the present invention, the look and feel module is further configured to store one or more predefined aesthetic and structural attributes, wherein each of the of the one or more predefined aesthetic and structural attributes defines the color of the layout and the visual style of the layout, corresponding to a tenant's website.

In an embodiment of the present invention, the page composition module is further configured to place a header, footer, and body in the tenant's website based on one or more predefined policies corresponding to the tenant.

In an embodiment of the present invention, the product extension framework further comprises a validation module, an internationalization and localization module, and a screen flow module. The validation module, in communication with the computer system, is configured to define tenant specific user input fields at the corresponding tenant's website, based on the one or more predefined policies corresponding to the tenant. The internationalization and localization module, in communication with the computer system, is configured to assign various demographic variables on the tenant's website based on the identified geography of the computing device, requesting access to the tenant's website. The screen flow module, in communication with the computer system, is configured to manage the navigational attributes of the tenant's website based on the one or more predefined policies corresponding to the tenant.

In an embodiment of the present invention, the product extension framework furthermore comprises a business logic module, and a database module. The business logic module, in communication with the computer system, is configured to process the invoked one or more computational processes, triggered by the one or more computing device, based on the one or more predefined policies. The database module, in communication with the computer system, is configured to store data related to each tenant's website generated in real-time.

In an embodiment of the present invention, the business logic module is further configured to process the invoked one or more computational processes corresponding to an e-commerce application, associated with the tenant's website.

### BRIEF DESCRIPTION OF THE ACCOMPANYING DRAWINGS

The present invention is described by way of embodiments illustrated in the accompanying drawings wherein:

FIG. 1 is a block diagram describing a system for creating e-commerce websites in real-time, in accordance with an embodiment of the present invention;

FIG. 2 is a block diagram of the Product Extension Framework facilitating generation of e-commerce website in real-time, in accordance with an embodiment of the present invention; and

FIG. 3 illustrates a flowchart of a method for generating an e-commerce website corresponding to a tenant in real-time, in accordance with an embodiment of the present invention.

### DETAILED DESCRIPTION OF THE INVENTION

A system and method that enables multi-tenancy while creating an e-commerce website is provided. Multi-tenancy represents a scenario in which multiple tenants are enabled to subscribe an e-commerce website based on their requirements. The e-commerce website includes one or more e-commerce applications. In addition, the e-commerce applications selected by the tenants are customized based on their requirements. Thereafter, a website corresponding to each tenant is generated in real-time with the customized e-commerce applications, selected by the tenant. Various business rules are then applied at the website corresponding to one or more predefined guidelines/policies, defined by the tenant.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

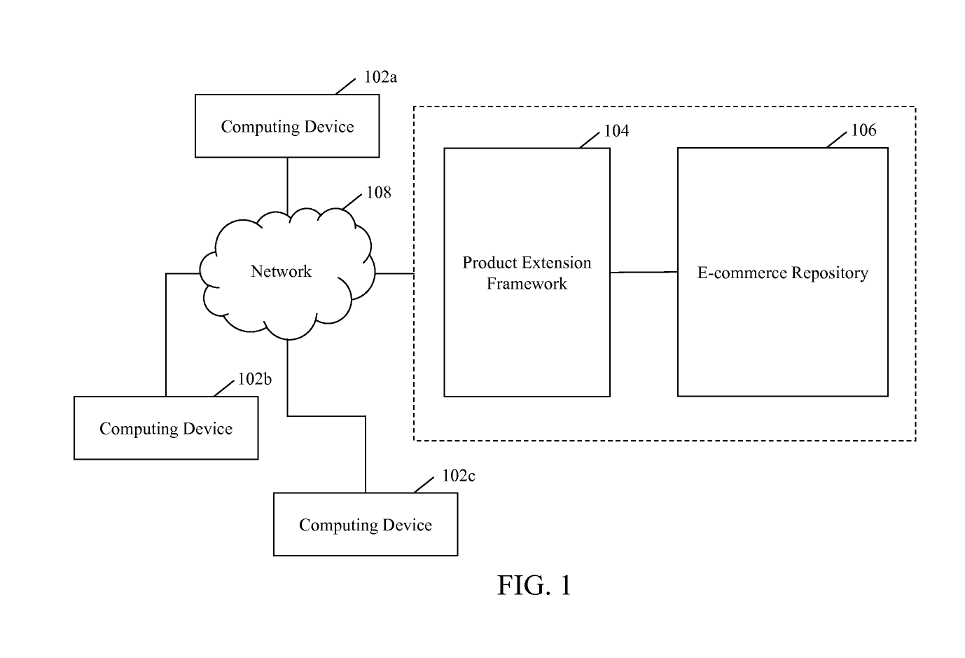

FIG. 1 is a block diagram describing a system for creating e-commerce websites in real-time, in accordance with an embodiment of the present invention.

In various embodiments of the present invention, the environment of the system comprises one or more computing devices 102a-102c, a network 108, a Product Extension Framework 104 and an e-commerce repository 106.

Various organizations publish their respective e-commerce websites to either promote their businesses or sell their products. In an embodiment of the present invention, an organization is enabled to subscribe an e-commerce website, from a service provider, using a Software as a Service (SaaS) model (pay as you go model). The organization subscribing a website is referred to as a tenant. In an embodiment of the present invention, the one or more computing devices 102a-102c use the network 108 as a communication gateway to access the e-commerce websites of the tenants, wherein the e-commerce websites are generated in real-time. For example, the network 108 may be internet, intranet, and so forth. In an embodiment of the present invention, a computing device 102a sends a request to access a tenant's website in real-time using a unique address of the tenant's website to the Product Extension Framework 104. Wherein, the unique address may a Uniform Resource Locator (URL), such as www.ebay.com, www.walmart.com and so forth. In an exemplary embodiment of the present invention the one or more computing devices 102a-102c may be a laptop, smart phone, personal digital assistant (PDA), tablet, personal computer, and so forth.

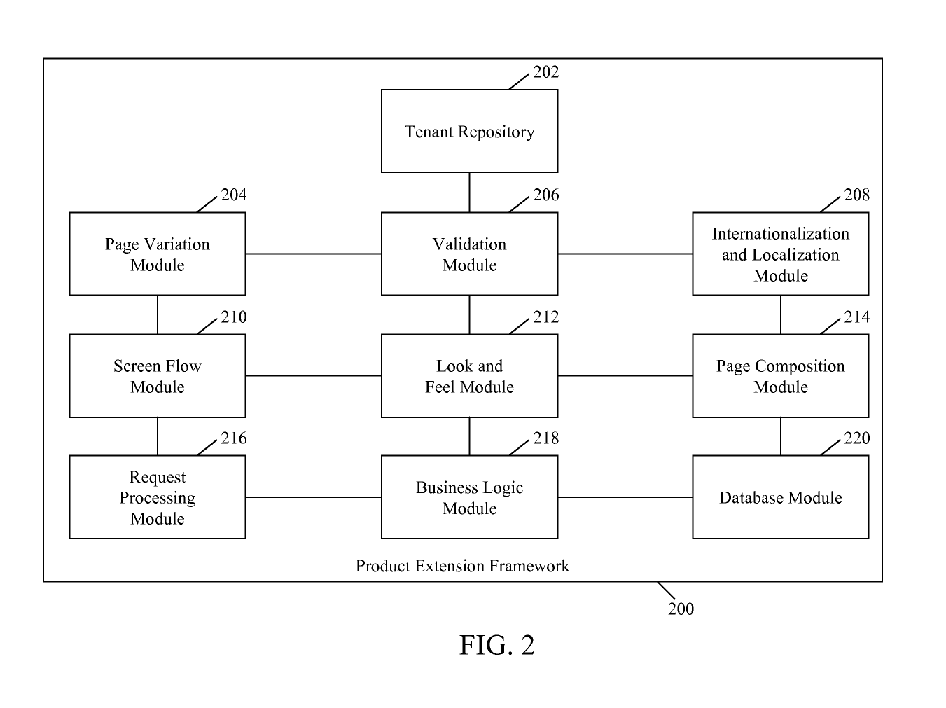

After receiving a request by the computing device 102a, for accessing a corresponding tenant's website, the Product Extension Framework 104 identifies the respective tenant and thereafter retrieves and applies various predefined guidelines/policies which are provided by the tenant, to generate the identified tenant's website in real-time. In an embodiment of the present invention, the predefined guidelines define the attributes/features and the functionalities of a website corresponding to a tenant. In an embodiment of the present invention, the Product Extension Framework 104 interacts with the e-commerce repository 106 to retrieve the one or more e-commerce applications. The Product Extension Framework 104 further incorporates the customized e-commerce application in the tenant's e-commerce website based on the tenant's requirement. The Product Extension Framework 104 is further explained in detail in FIG. 2.

In an embodiment of the present invention, the e-commerce repository 106 includes various e-commerce applications. In an exemplary embodiment of the present invention, the e-commerce repository 106 may be ATG Commerce Server and the e-commerce applications may be developed using ATG commerce server. Each of the e-commerce applications stored in the e-commerce repository 106 are unique and are pre-developed to provide a specific functionality, such as a search functionality, a payment functionality, an interactive display functionality and so forth. The e-commerce applications may include, but not limited to, a search interface, a flash image component, a user login component, a payment module. In an embodiment of the present invention, one or more e-commerce applications are selected based on a tenant specific predefined guideline. Further, the selected one or more e-commerce applications may be suitably incorporated in the tenant's website, based on the tenant specific predefined guideline. In an exemplary embodiment of the present invention, one or more e-commerce application, such as a search application and a payment application, may be selected to be incorporated at a tenant's website, based on a tenant's requirement. Thereafter, the details related to the selected e-commerce applications are recorded in a guideline specific to the tenant The predefined guideline specific to the tenant is stored at the Product Extension Framework 104 and is correspondingly mapped to the respective tenant.

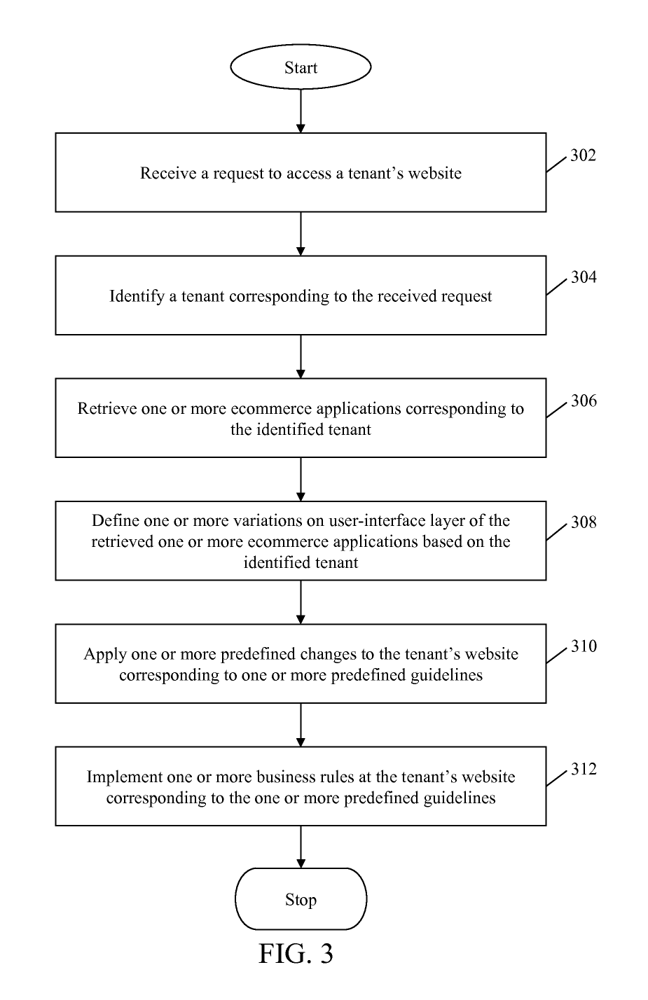

For example, the computing device 102a may request the Product Extension Framework 104 to access eBay's website. After which, the Product Extension Framework 104 identifies the requested tenant, such as eBay, and retrieves various predefined guidelines corresponding to eBay (tenant). Thereafter, one or more e-commerce applications are retrieved from the e-commerce repository 106 based on the tenant specific predefined guidelines. Consecutively, the tenant's website including the tenant specific one or more e-commerce applications is generated. The methodology to generate a tenant's website, which includes one or more subscribed e-commerce applications, is explained in detail in FIG. 3.

FIG. 2 is a block diagram of the Product Extension Framework facilitating generation of e-commerce website in real-time, in accordance with an embodiment of the present invention.

In various embodiments of the present invention, the computing device 102a (FIG. 1) may request the Product Extension Framework 104 to access a tenant's e-commerce website. After receiving the request the Product Extension Framework 200 identifies the tenant linked to the received request. The Product Extension Framework 200 then retrieves various predefined guidelines/policies related to the identified tenant to generate a real-time website in conjunction with the e-commerce repository 106 (FIG. 1). In an embodiment of the present invention, the predefined guidelines/policies include one or more decision points. The one or more decision points are used to process the received request for generating the tenant's e-commerce website. The one or more decision points may be unique for each tenant. In various embodiment of the present invention, the predefined guidelines/policies are stored at the Product Extension Framework 200 and are correspondingly mapped to each identified tenant.

The Product Extension Framework 200 comprises a Tenant Repository 202, a Page Variation Module 204, a Validation Module 206, an Internationalization and Localization Module 208, a Screen Flow Module 210, a Look and Feel Module 212, a Page Composition Module 214, a Request Processing Module 216, a Business Logic Module 218, and a Database Module 220.

In an embodiment of the present invention, the Tenant Repository 202 comprises unique identification codes which are allocated to the tenants registered with the Product Extension Framework 200. In various embodiment of the present invention the unique identification code is an alphanumeric identification code which is referred as “Tenant ID”. Further, each Tenant ID is associated with a predefined guideline corresponding to the respective tenant. The predefined guideline respectively defines the context of the tenant's website and identifies e-commerce applications registered with the corresponding tenant. It may be appreciated by a person skilled in the art that guidelines are defined by a system administrator/developer for each tenant respectively. Further, guidelines are based on the requirements of the tenant and each guideline may be unique for a respective tenant. In an exemplary embodiment of the present invention, a tenant, such as eBay, may be allotted a Tenant ID ‘eBay1001’. In addition various business units of eBay and their respective URLs/web links are all linked with eBay's unique Tenant ID, i.e. ‘eBay1001’. In another embodiment of the present invention, each tenant is associated with a specific context and is assigned a context value. The context includes various operational properties and behaviors attributes associated with the tenant. For example, the operational properties and behaviors attributes include, but are not limited to, a geographical location, a unit of an enterprise, and so forth.

The Page Variation Module 204 assigns a preset layout at a tenant's website based on the predefined guidelines defined for a particular tenant. The predefined guidelines are further linked to the tenant using the tenant's unique alphanumeric identification code (Tenant ID). In an embodiment of the present invention, the Page Variation Module 204 is a view resolver servlet. Once, the Tenant Repository 202 identifies a tenant, requested by a computing device 102a (FIG. 1), it retrieves various predefined guidelines corresponding to the identified tenant from the Tenant Repository 202. Thereafter, the Page Variation Module 204 assigns a corresponding layout at the tenant's website based on the retrieved predefined guidelines. In various embodiment of the present invention, the Page Variation Module 204 generates a layout for a corresponding tenant based on predetermined conditions, such as geographical location. In an exemplary embodiment of the present invention, a computing device 102a (FIG. 1) requests to access Walmart's website, wherein the computing device 102a (FIG. 1) is located in India. After identifying the requested tenant (Walmart), the Page Variation Module 204 determines the geographical location of the computing device 102a (FIG. 1), based on user input or auto generated server address. Subsequently, the Page Variation Module 204 retrieves various predefined guidelines associated with the Tenant ID and assigns a layout based on the predefined guidelines corresponding to the determined geographical location (India). It may be apparent to a person skilled in art that various layouts may be designed for different geographies for a corresponding tenant. For example, Walmart USA may have weekly promotions available at its local store displayed on its USA website. On the contrary Walmart India may only list all the goods available at their Indian stores on its India website. Further, various other alteration to the layout of the website may also be made based on language, specific business unit of the tenant and so forth. Furthermore, each layout is designed to be compatible with various e-commerce applications, pre-stored at the e-commerce repository 106 (FIG. 1).

In an embodiment of the present invention, the Page Variation Module 204 also modifies the URL of the requested tenant based on the identified location, i.e. in case a computing device 102a (FIG. 1) sends a request to access www.walmart.com, the Page Variation Module 204 after detecting the geographical location of the computing device 102a (FIG. 1) to be ‘India’ replaces the URL of Walmart (tenant) to www.walmart.in. Thereafter, the Page Variation Module 204 generates Walmart's website with the layout that is designated for ‘India’.

In an embodiment of the present invention, the Validation Module 206 provides a configurable validation mechanism for an e-commerce application. The Validation Module 206 populates tenant specific data at the corresponding tenant's website. In various embodiments of the present invention, the Validation Module 206 applies predetermined set of rules corresponding to the identified tenant, wherein the predetermined set of rules are stored in validation files which comprises various user input fields and respective options to be displayed at the tenant's website based on user selection and Tenant ID.

In another embodiment of the invention, the Validation Module 206 loads a validation file that is associated with the identified tenant. The validation file includes the validations to be presented to a user at the tenant's ecommerce website/web page. For example, validation module may vary the validation requirements, such as fields related to name, city zip code, etc., corresponding to the requirements for a particular tenant. In an exemplary embodiment of the present invention, the validation file defines all user input fields, such as a country dropdown field, wherein a user is enabled to select a city from a defined list of cities for the selected country.

In yet another embodiment of the present invention, the Validation Module 206 modifies a validator class or loads an associated validation policy to apply the validations on the web tier, based on the identified tenant. The validations to be presented to the user corresponding to the tenant are stored in a form of an ‘Extensible Markup Language (XML)’ file corresponding to an e-commerce application. The modified validator identifies the XML file corresponding to the identified tenant and runs the corresponding validations associated with the tenant in a displayed form on a web page.

The Internationalization and Localization Module 208 assigns various demographic variables/locale on the tenant's website based on the identified geography of the computing device 102a (FIG. 1), requesting access to the tenant's website. In an embodiment of the present invention, the Internationalization and Localization Module 208 defines the currency, date format, language, and specific messages, such as holiday messages, at various structural and functional components of the tenant's website, based on the identified geography of the requesting computing device 102a (FIG. 1).

In an exemplary embodiment of the present invention, a computing device 102a (FIG. 1) requests to view a tenant's website, wherein the computing device 102a (FIG. 1) is located in India. After identifying the geography of the computing device 102a (FIG. 1), the Internationalization and Localization Module 208 updates the currency unit displayed at the tenant's website to INR (Indian Rupee) and the date format at the tenant's website to DD/MM/YY. In another embodiment of the present invention, a computing device 102b (FIG. 1) request to view a tenant's website, wherein the computing device 102b (FIG. 1) is located in United States of America. After identifying the geography of the computing device 102b (FIG. 1), the Internationalization and Localization Module 208 updates the currency unit displayed at the tenant's website to USD (United States Dollar) and the date format at the tenant's website to MM/DD/YY.

It may be apparent to a person skilled in the art, that each of the e-commerce applications retrieved from the e-commerce repository 106 (FIG. 1) can further be updated by the Internationalization and Localization Module 208, based on the identified geography of the requesting computing device 102a (FIG. 1) and the predefined guidelines corresponding to the tenant.

The Screen Flow Module 210 manages the navigational attributes of the tenant's website based on the predefined guidelines/instruction provided by the tenant. In an embodiment of the present invention, the Screen Flow Module 210 implements an inbuilt ‘form handler’ servlet to manage the navigational functionality of the tenant's website. The ‘form handler’ servlet associates inter-connected web-links/addresses of documents/web pages corresponding to the tenant's website. Further, the ‘form handler’ servlet stores temporary data corresponding to the request, for accessing the tenant's website. In an exemplary embodiment of the present invention, the Product Extension Framework 200 in conjunction with the e-commerce repository 106 (FIG. 1) presents a tenant's website, such as Walmart's website, to a computing device 102a (FIG. 1). Thereafter, in case a user of the computing device 102a (FIG. 1) selects a product, displayed at Walmart's website, and clicks at the ‘Buy’ button, the ‘form handler’ servlet stores the data filled by the user (if any) and the information corresponding to the product's web-link. Subsequently, the form handler dynamically routes the computing device 102a (FIG. 1) to a “Checkout Cart” web page. Further the ‘form handler’ servlet fills the “Checkout Cart” webpage based on the stored data. In another exemplary embodiment of the present invention, the Screen Flow Module 210 generates dynamic web-links to navigate to different sections and e-commerce applications of the tenant's website, which enables a computing device 102a (FIG. 1) to navigate the tenant's website effortlessly. It may be apparent to a person skilled in the art that various other navigational variations can be applied at the tenant's website based on the requirements of the tenant. In an embodiment of the present invention, the system administrator/developer stores the navigational constraints of a tenant in its associated predefined guideline.

The Look and Feel Module 212 defines the color and style attributes of the tenant's website. In an embodiment of the present invention, the Look and Feel Module 212 stores predefined aesthetic and structural attributes/elements of a tenant's website. Each of the aesthetic and structural elements defines the color of the layout and the visual style of the layout, corresponding to a tenant's website. In an exemplary embodiment of the present invention, while generating the tenant's (eBay) website the Look and Feel Module 212 retrieves the predefined aesthetic and structural elements corresponding to eBay's website. Thereafter, the Look and Feel Module 212 defines the color and style of the website's layout, based on the requirement of the tenant, i.e. the aesthetic and structural elements define the background color of the website's layout to be ‘light blue’ (HEX Code→# ADD8E6), and the font style of the layout to be ‘Arial’.

In an embodiment of the present invention, the Look and Feel Module 212 comprises various custom tags, corresponding to a tenant's website. The custom tags stores information corresponding to the aesthetic and structural elements of the tenant's website and are used to invoke dynamic variation of the tenant's website. The custom tags are java objects that are developed by a system administrator based on the tenant's requirements.

The Page Composition Module 214 defines the composition/content of the tenant's website. In an embodiment of the present invention, the Page Composition Module 214 places the header, footer, and the body of the website in the tenant's website based on predefined guidelines/policies corresponding to a tenant. The Page Composition Module 214 stores predefined locations of the visual elements of the website, such as header, footer, banner, and so forth. While generating the requested tenant's website, the Page Composition Module 214 inserts the respective visual elements of the website in the tenant's website, extracted from the predefined location. Further, the Page Composition Module 214 monitors and subsequently assigns the position of each of the visual elements of the website based on the predefined guidelines of the corresponding tenant. In an embodiment of the present invention, the visual elements corresponding to each tenant website are stored at the Database Module 220. In an exemplary embodiment of the present invention, when the Product Extension Framework 200 receives a request to generate a tenant's website, the Page Composition Module 214 retrieves the pre-stored visual elements from a predetermined location, for the corresponding tenant's website. Thereafter, the Page Composition Module 214 inserts the visual elements at the tenant's website to be displayed to a computing device 102a (FIG. 1), requesting to view the tenant's website.

The Request Processing Module 216 invokes various computational processes initiated by the one or more computing devices 102a-102c (FIG. 1), corresponding to an e-commerce application at a tenant's website. In an embodiment of the present invention, a user of the computing device 102a (FIG. 1) enters the required text/data, such as payment and product details, at an e-commerce application (payment gateway), displayed at the tenant's website, to invoke the computational process. Thereafter, the Request Processing Module 216 triggers the computational process initiated by the computing device 102a (FIG. 1), corresponding to the e-commerce application, based on predefined conditions. In an embodiment of the present invention, the predefined conditions may be stored at the e-commerce repository 106 (FIG. 1). The predefined conditions corresponding to each e-commerce application associated with a registered tenant are stored at the ATG Commerce server in an ATG library.

In an embodiment of the present invention, the Request Processing Module 216 utilizes various Java form beans to invoke the computational process initiated by a computing device 102a (FIG. 1). The form beans are components created for a particular task. The form is a table filled by a user of the computing device 102a (FIG. 1). Thereafter, a bean object (Java object) is triggered to initiate the processing based on predefined conditions and the information provided by the user (through the form). In an embodiment of the present invention, the predefined conditions can be set and modified with the help of various predefined guidelines associated with each corresponding tenant. In an embodiment of the present invention, various form beans are predefined in the ATG library corresponding to the e-commerce applications, which may be used to process an e-commerce application computational process.

In an exemplary embodiment of the present invention, a tenant's website includes a payment gateway e-commerce application. A user of the computing device 102a (FIG. 1) fills the user field displayed through the e-commerce application and subsequently sends the request for further processing. The Request Processing Module 216 in conjunction with the Business Logic Module 218 provides the processed information to the user.

The Business Logic Module 218 is configured to process the invoked computational processes (corresponding to an e-commerce application of a respective tenant) triggered by a computing device 102a (FIG. 1) based on predefined guidelines. In an embodiment of the present invention, the Business Logic Module 218 includes various business logics corresponding to respective tenants. The business logic includes computational steps, which are predefined corresponding to the functional and business attributes of an e-commerce application respective to a tenant. For example, computing data, calculating taxes at a payment gateway, calculating available discounts at a check-out application, and so forth.

In an embodiment of the present invention, the Business Logic Module 218 comprises various components. Each component is configured to perform a specific functional operation, such as a mathematical operation. For example, a component may be developed to calculate taxes at a payment gateway application corresponding to a tenant's e-commerce website. It may be apparent to a person skilled in the art that a collection of components included in the Business Logic Module 218 may be used for various quantitative processing based on the requirement of the corresponding business logic (defined by the requirements of the tenant specific e-commerce application). Further, a selection of the components may be repeated for various e-commerce applications to execute similar business logics/mathematical operations. The components of the Business Logic Module 218 are controlled by a pipeline manager module (not shown). In an embodiment of the invention, the Business Logic Module 218 processes the business logic using one or more pipeline managers. A pipeline manager is a chain of components hooked together to execute the business logic. Each component performs a particular business function. Further, the extent of variation in the business logic between different tenants may be different. For example, when the business logic needs to be varied completely for two tenants, the form handler itself is varied and a separate pipeline manager is created to implement the new business logic. On the other hand, if only a few variations are required in the business logic for two tenants, only a few components are varied in the single pipeline manager. These components may be created and easily hooked into the existing pipeline manager. In an embodiment of the present invention, each of the components configured to perform specific mathematical operations comprises conventional computational elements such as a processor, memory (RAM and ROM), BUS and so forth.

In an exemplary embodiment of the present invention, after the user of the computing device 102a (FIG. 1) submits the required details in a user-form at a particular tenant's website linked to a payment gateway, the Business Logic Module 218 is triggered by the Request Processing Module 216 to perform computation based on the predefined business logic, corresponding to the tenant's (Walmart) requirement. The Business Logic Module 218 invokes the pipeline manager module to retrieve the corresponding business logic and predefined conditions corresponding to the payment gateway of Walmart. Thereafter, the functional operations, such as calculation of discount, calculation of taxes based on geography or product specific tenant criteria, and so forth, are performed by a selection of components controlled by the pipeline manger. The computed result is displayed to the user of the computing device 102a (FIG. 1), via a display of a computing device/system.

The Database Module 220 is enabled to store data related to each tenant's website generated in real-time. In various embodiment of the present invention the Database Module 220 in conjunction with the Tenant Repository 202 stores tenant specific information corresponding to e-commerce applications subscribed by the tenant. In an embodiment of the present invention, the user accesses the Database Module 220 using different strategies, depending on the strategies followed in e-commerce repository 106 (FIG. 1). In an exemplary embodiment of the present invention, the user access strategies followed in ATG commerce server. The e-commerce repository 106 (FIG. 1) further includes a library, such as ATG library, which comprises data corresponding to each e-commerce application included in the e-commerce repository 106 (FIG. 1). The ATG commerce server follows ‘Data Anywhere’ architecture. This architecture enables object to database table mapping and facilitates ‘an item descriptor name’ to identify the mapping. The Database Module 220 creates different item descriptor names to achieve variations in database tables and columns in the database associated with each of the context associated with the identified tenant.

In an exemplary embodiment of the invention, the user accesses the Database Module 220 for transaction based sub-systems such as shopping cart, etc., by making the payment for the product he has selected through the tenant. It may be apparent to any person skilled in the art that the available payment options and the information to be provided corresponding to the payment may be different for different tenants. In an embodiment of the invention, for transaction based sub-systems, the Database Module 220 extends an entity, for example, the ‘credit card’ component of the library of the e-commerce repository 106 (FIG. 1), such as ATG commerce server, by adding an identifier. Further, database module varies the ‘credit card’ component on the basis of the tenant in the form handler. The form handler is associated with the context of the tenant and variation resolver components.

In another exemplary embodiment of the invention, for a search based sub-system, the user accesses the database by searching for a particular product through the tenant. The Database Module 220 returns an object in response to the search query entered by the user. Further, the object is set in the form handler and shown to the user. Since the fields in the retrieved catalog may be different for different tenants, the Database Module 220 uses tenant-specific product descriptor names to fetch different objects and show the search result.

In yet another exemplary embodiment of the invention, for a registration sub-system, a user accesses the database by registering himself with the tenant. It may be apparent to any person skilled in the art that each new user corresponds to a specific tenant. Further, each tenant has different attributes. The Database Module 220 creates tenant specific form handlers. Further, the tenant specific form handlers access the property list of that particular tenant stored in the database, and modify it for the new attributes corresponding to the new users. It may be apparent to any person skilled in the art that the Database Module 220 may be accessed for various reasons such as, accessing the database while making payment, searching, creating a profile of a new user with the tenant, and so forth.

FIG. 3 illustrates a flowchart of a method for generating an e-commerce website corresponding to a tenant in real-time, in accordance with an embodiment of the present invention.

Each tenant is enabled to select one or more e-commerce applications from the e-commerce repository 106 (FIG. 1) based on its requirements. In an embodiment of the present invention, the e-commerce repository 106 (FIG. 1) is ATG Commerce Server. Further, a developer defines the functional, structural and presentational requirements of the website, via a user interface, corresponding to the tenant, which are further stored in conjunction with one or more predefined guidelines. The one or more predefined guidelines corresponding to each tenant is stored at the Product Extension Framework 104 (FIG. 1). The Product Extension Framework 104 (FIG. 1) generates the tenant's website in conjunction with the e-commerce repository 106 (FIG. 1) in real-time.

At step 302, a request is received to access a tenant's website. In an embodiment of the present invention, a user requests to access the tenant's website with the help of the tenant's URL. In an exemplary embodiment of the present invention, a user accesses eBay's website through an internet browser, such as Internet Explorer, by submitting a request at eBay's URL, www.ebay.com.

At step 304, a tenant corresponding to the received request is identified. In an embodiment of the present invention, each tenant is allotted a ‘Tenant ID’, wherein the ‘Tenant ID’ is an alphanumeric code, which is unique for each tenant. The ‘Tenant ID’ is associated to all the URLs of the tenant. After receiving the request to access a tenant's website, the corresponding tenant is verified based on the URL. Thereafter, the ‘Tenant ID’ corresponding to the tenant is identified. In an embodiment of the present invention, the ‘Tenant ID’ further includes the one or more predefined guidelines corresponding to each tenant, wherein the one or more predefined guidelines includes various functional and aesthetic attributes related to the tenant's website.

At step 306, one or more e-commerce applications corresponding to the identified tenant is retrieved. In an embodiment of the present invention, the one or more predefined guidelines/policies, associated with the ‘Tenant ID’, includes a list of one or more e-commerce applications subscribed by the tenant. Once, the ‘Tenant ID’ corresponding to the tenant is identified, the corresponding list of subscribed one or more e-commerce applications are extracted. Subsequently, the one or more e-commerce applications subscribed by the tenant are retrieved from the e-commerce repository 106 (FIG. 1) and are further associated with the tenant's website.

At step 308, one or more variations on user-interface layer of the retrieved e-commerce applications are defined, based on the identified tenant. Each e-commerce application associated with the tenant's website is customized based on the one or more predefined guidelines of the tenant. In an embodiment of the present invention, a tenant may define a structural outlook for a payment gateway application, such as the tenant's logo, color, font, style of box, and so forth. Also, the tenant may define specific functionality for an associated e-commerce application, such as limitation to use only VISA™ credit card at the payment gateway application. Therefore, the user-interface of each of the e-commerce applications embedded at the tenant's website is customized based on the one or more predefined guidelines of the corresponding tenant.

At step 310, one or more predetermined changes are applied to the tenant's website corresponding to the one or more predefined guidelines. In an embodiment of the present invention, the one or more predefined guidelines corresponding to a tenant comprises various aesthetic and cosmetic attributes of the tenant's websites. The attributes may include features such as, placement of banner at the website, embedded logo of the tenant, background color of the website, embedded image, animation at the website, and so forth. In an embodiment of the present invention, each picture, animation, and text corresponding to the aesthetic attributes of the tenant's website are stored at the Database Module 220 (FIG. 2). The Database Module 220 (FIG. 2) further associates an ‘item descriptor name’ to each of the tenant website's attributes. Thereafter, while generating the tenant website, the one or more predefined guidelines provides links to the ‘item descriptor name’ and subsequently administers the position and implementation of the attributes based on the tenant's requirement.

At step 312, one or more business rules are implemented at the tenant's website corresponding to the one or more predefined guidelines. In an embodiment of the present invention, business rules are computational steps/logic for each e-commerce application corresponding to a tenant. A tenant may define specific computational steps for different e-commerce applications based on its requirements. The computational steps associated with the corresponding e-commerce applications are defined by the one or more predefined guidelines corresponding to the tenant. In an exemplary embodiment of the present invention, a tenant, such as eBay, may define specific taxation and discount rules for a payment application. Therefore, different tenants may define various computational rules corresponding to their subscribed e-commerce applications based on its requirements. The business rules are further explained in conjunction with FIG. 2.

The present invention may be implemented in numerous ways including as an apparatus, method, or a computer program product such as a computer readable storage medium or a computer network wherein programming instructions are communicated from a remote location.

Various embodiments of the present invention may be implemented via one or more computer systems. The computer system includes at least one processing unit and memory. The processing unit executes program instructions and may be a real or a virtual processor. The computer system is not intended to suggest any limitation as to scope of use or functionality of described embodiments. Typical examples of a computer system include a general-purpose computer, a programmed microprocessor, a micro-controller, a peripheral integrated circuit element, and other devices or arrangements of devices that are capable of implementing the steps that constitute the method of the present invention. In an embodiment of the present invention, the memory may store software for implementing various embodiments of the present invention.

The present invention may suitably be embodied as a computer program product for use with a computer system. The method described herein is typically implemented as a computer program product, comprising a set of program instructions which is executed by a computer system or similar device. The set of program instructions may be a series of computer readable codes stored on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A computer-implemented method for creating one or more e-commerce websites in real-time, the method comprising:
receiving, via a user interface on a computing device, request to access a tenant's website;
identifying, using a computer system, a tenant corresponding to the received request;
associating, using the computer system, one or more e-commerce applications, corresponding to the identified tenant, to the tenant's website; and
applying, using the computer system, one or more predetermined changes to the tenant's website corresponding to one or more predefined policies for generating the e-commerce website.

2. The computer-implemented method of claim 1, wherein identifying the tenant corresponding to the received request further comprises categorizing the tenant based on a tenant ID, wherein the tenant ID is an alphanumeric code unique for each tenant.

3. The computer-implemented method of claim 2, wherein the tenant ID corresponding to the tenant is further associated with one or more predefined policies, wherein the one or more predefined policies includes at least one tenant requirement.

4. The computer-implemented method of claim 3, wherein associating one or more e-commerce applications corresponding to the identified tenant further comprises:
identifying, using the computer system, the one or more e-commerce applications based on the tenant ID corresponding to the tenant; and
retrieving, using the computer system, the identified one or more e-commerce applications from an e-commerce repository.

5. The computer-implemented method of claim 4, wherein the e-commerce repository is ATG Commerce Server.

6. The computer-implemented method of claim 1, wherein the one or more predetermined changes comprise at least one of color of the website, font used in the website, placement of one or more data in the website.

7. The computer-implemented method of claim 1, wherein the method for creating one or more e-commerce websites in real-time, further comprises:
defining, using the computer system, one or more variations on the user-interface layers of the one or more e-commerce applications associated with the tenant's website; and
implementing, using the computer system, one or more business rules at the tenant's website corresponding to the one or more predefined policies.

8. The computer-implemented method of claim 7, wherein the one or more variations on the user-interface layers of the one or more e-commerce applications comprise at least one of structural variations, aesthetical variations, and functional variations.

9. The computer-implemented method of claim 8, wherein the one or more variations on the user-interface layers of the one or more e-commerce applications, corresponding to the identified tenant, are defined based on the one or more predefined policies corresponding to the tenant.

10. A system for creating one or more e-commerce websites in real-time, the system comprising:
an e-commerce repository, in communication with a computer system, configured to store one or more pre-developed e-commerce applications; and
a product extension framework, in communication with the computer system, configured to generate a tenant's website including at least one e-commerce application in real-time, wherein the at least one e-commerce application is selected from the one or more pre-developed e-commerce applications.

11. The system of claim 10, wherein the at least one e-commerce application is selected based on one or more predefined policies corresponding to the tenant.

12. The system of claim 10, wherein the product extension framework comprises:
a tenant repository, in communication with the computer system, configured to store tenant IDs' of one or more tenants, wherein the tenant ID is a unique alphanumeric identification code corresponding to a tenant;
a page variation module, in communication with the computer system, configured to assign a preset layout at a tenant's website based on one or more predefined policies, wherein the one or more predefined policies are associated with the tenant ID of the corresponding tenant;
a look and feel module, in communication with the computer system, configured to define the color and style attributes of the tenant's website;
a page composition module, in communication with the computer system, configured to define the composition/content of the tenant's website; and
a request processing module, in communication with the computer system, configured to process plurality of computational processes, invoked by one or more computing devices, corresponding to an e-commerce application at the tenant's website.

13. The system of claim 12, wherein the look and feel module is further configured to store one or more predefined aesthetic and structural attributes, wherein each of the of the one or more predefined aesthetic and structural attributes defines the color of the layout and the visual style of the layout, corresponding to a tenant's website.

14. The system of claim 12, wherein the page composition module is further configured to place a header, footer, and body in the tenant's website based on one or more predefined policies corresponding to the tenant.

15. The system of claim 12, wherein the product extension framework further comprises:
a validation module, in communication with the computer system, configured to define tenant specific user input fields at the corresponding tenant's website, based on the one or more predefined policies corresponding to the tenant;
an internationalization and localization module, in communication with the computer system, configured to assign various demographic variables on the tenant's website based on the identified geography of the computer system, requesting access to the tenant's website; and
a screen flow module, in communication with the computer system, configured to manage the navigational attributes of the tenant's website based on the one or more predefined policies corresponding to the tenant.

16. The system of claim 15, wherein the product extension framework furthermore comprises:
a business logic module, in communication with the computer system, configured to process the invoked one or more computational processes, triggered by the one or more computing devices, based on the one or more predefined policies; and
a database module, in communication with the computer system, configured to store data related to each tenant's website generated in real-time.

17. The system of claim 16, wherein the business logic module is further configured to process the invoked one or more computational processes corresponding to an e-commerce application, associated with the tenant's website.

18. A computer program product comprising a computer readable medium having a computer-readable program code embodied thereon to create one or more e-commerce websites in real-time, the computer-readable program code comprising instructions that, when executed by the computer system, cause the computing system to:
receive request for accessing a tenant's website;
identify a tenant corresponding to the received request;
associate one or more e-commerce applications corresponding to the identified tenant to the tenant's website; and
apply one or more predetermined changes to the tenant's website corresponding to one or more predefined policies for generating the e-commerce website.

19. The computer program product of claim 18, wherein the computer-readable code to identify the tenant corresponding to the received request further comprises instructions that, when executed by the computing system, cause the computing system to categorize the tenant based on a tenant ID, wherein the tenant ID is an alphanumeric code unique for each tenant.

20. The computer program product of claim 19, wherein the tenant ID corresponding to each tenant is further associated with one or more predefined policies corresponding to a tenant, wherein the one or more predefined policies includes at least one tenant requirement.

21. The computer program product of claim 18, wherein the computer-readable code to associate one or more e-commerce applications corresponding to the identified tenant further comprises instructions that, when executed by the computing system, cause the computing system to:
identify the one or more e-commerce applications based on the unique tenant ID corresponding to a tenant; and
retrieve the identified one or more e-commerce applications from an e-commerce repository.

22. The computer program product of claim 18, wherein the computer-readable code to create one or more e-commerce websites in real-time further comprises instructions that, when executed by the computing system, cause the computing system to:
define one or more variations on the user-interface layers of the one or more e-commerce applications corresponding to the identified tenant; and
implement one or more business rules at the tenant's website corresponding to the one or more predefined policies.
